(19) United States
(12) Patent Application Publication
(10) Pub. No.: US 2016/0206979 A1
(43) Pub. Date: Jul. 21, 2016

(54) Filter Medium and Filter Element Having a Filter Medium

(71) Applicant: Mann+Hummel GMBH, Ludwigsburg (DE)

(72) Inventors: Lars Spelter, Ditzingen (DE); Sebastian Neubauer, Marbach (DE); Claudia Wagner, Stuttgart (DE)

(21) Appl. No.: 15/001,542

(22) Filed: Jan. 20, 2016

(30) Foreign Application Priority Data
Jan. 20, 2015 (DE) 102015000361.5

(51) Int. Cl. B01D 29/15; B01D 29/21; F02M 37/22

(52) U.S. Cl. CPC B01D 29/15; F02M 37/22; B01D 29/21

(57) ABSTRACT

A filter medium comprising: a first media layer; a second media layer; and at least one third media layer; wherein the second media layer is arranged downstream from the first media layer in the intended direction of flow of the filter medium; wherein the third media layer is arranged downstream from the second media layer in the intended direction of flow through the filter medium; wherein the first media layer has a degree of particle separation, which is lower than the degree of particle separation of the second media layer; wherein the second media layer has a degree of particle separation which is lower than the degree of particle separation of the third media layer; and wherein the media layers are arranged loosely and not bonded to one another, or are arranged loosely and bonded in a spot-bonded manner.

### TECHNICAL FIELD

The invention relates to a filter medium for filtering fluids, in particular for filtering liquids such as fuels, for example, as well as a filter element having such a filter medium for use as a fuel filter for an internal combustion engine in particular.

### BACKGROUND OF THE INVENTION

Transmission oil filters having a glass fiber layer laminated on both sides to a spun-bonded nonwoven are known. The spun-bonded nonwoven improves the handleability of the glass fiber layer, for example, in the process of manufacturing the filter. Multilayer filters for liquids in which a melt-blown nonwoven is combined with a downstream layer of cellulosic filter paper are known.

The terms melt-blown, spun-bonded, wet-laid and dry-laid layer production, cramped nonwoven, filament spun-bonded nonwoven and cross-laid nonwoven are defined in, for example, “Nonwoven Materials: Raw Materials, Production, Use, Properties, Testing,” 2^{nd} edition, 2012, Weinheim, ISBN: 978-3-527-31519-2.

It is known from filtration of air that fiber fragments from glass fiber media may enter the clean air region. Such a release can also be observed in filtration of liquids with glass fiber media laminated to spun-bonded nonwovens.

EP 2 321 029 A1 has a filter medium with a multilayer design. The individual layers are laminated onto one another. In this structure, a possible gradual multilayer design is interrupted by the lamination layers. Therefore, there is a decline in both the absorption capacity and the lifetime of the filter medium.

U.S. Pat. No. 5,770,077 A also discloses a filter medium having a multilayer structure. It has a cover nonwoven as the top layer. Furthermore, the material layers of the filter medium are bonded together over large areas in a special bonding technique.

### SUMMARY OF THE INVENTION

The object of the invention is to create a filter medium that will permit a high degree of separation of particles while achieving a long lifetime accordingly.

According to one aspect of the present invention, with a filter medium having a first media layer, a second media layer and at least one third media layer, wherein the second media layer is arranged downstream from the first media layer in an intended direction of flow of the filter medium, and wherein the third media layer is arranged in a direction of flow of the filter medium downstream from the second media layer when used as intended, the aforementioned objected is achieved by the fact that the first media layer has a lower degree of particle separation than the degree of particle separation of the second media layer, and the second media layer has a lower degree of particle separation than the degree of particle separation of the third media layer, and all of the media layers are not bonded together firmly or are bonded together firmly only in spots.

The degree of separation here is defined according to the standard ISO 19438:2003.

The intended direction of flow runs transversely or orthogonally to the first, second and third media layers. The fluid stream to be filtered thus flows through all the media layers of the filter medium.

A long lifetime and a high degree of separation of particles are therefore achieved through the filter medium according to the invention having a degree of particle separation that increases gradually and having loosely arranged material layers or those bonded in spots.

Favorable embodiments and advantages of the invention are derived from the additional claims, the description and the drawing.

It is advantageous in particular if at least one of the second and/or third media layers has a degree of particle separation of more than 95% for particles with an average particle diameter of more than 4 μm according to ISO 19138. Material layers with a degree of particle separation of more than 95% are understood to be main filter layers and make it possible to remove or at least reduce in particular particles between 1 and 50 μm from the fluid.

It is advantageous if at least one of the first and/or second media layers has a degree of separation of less than 90% for particles larger than 4 μm according to ISO 19138. This media layer or these media layers can be used as prefilters, in which more than 90% of particles with an average particle size of more than 50 μm can collect. These particles therefore do not clog the downstream main filter layers.

At least one of the media layers can especially advantageously consist of at least 20 wt % preferably at least 50 wt %, especially preferably at least 95% glass fibers. Glass fiber materials are very stable mechanically and chemically.

In one advantageous embodiment variant, the degrees of particle separation of two successive media layers for particles larger than 4 μm according to ISO 19138 may differ from one another by at least 3%, preferably by at least 5%. In a particularly preferred embodiment variant, the degrees of particle separation of all successive media layers may each differ from one another by at least 3%.

In a particularly preferred embodiment variant, the at least three-layer filter medium has a first media layer with a degree of separation of less than 50%, preferably between 20% and 49% for particles larger than 4 μm according to ISO 19138, and a second media layer with a degree of separation between 50% and 95%, preferably between 80% and 94% for particles larger than 4 μm according to ISO 19138 and the third media layer with a degree of separation of more than 98%, in particular between 98.2% and 99.5% for particles larger than 4 μm according to ISO 19138.

To obtain a favorable flow of the fluid to be filtered but nevertheless have a certain strength, it is advantageous if the three media layers are connected to one another over less than 3% of their area content, preferably over less than 1.5% of their area content. Firm bonding in spots, for example, can be achieved by adhesive bonding or spot bonding.

In a preferred embodiment variant, the filter medium has a nanofiber layer in the intended direction of flow of the filter medium downstream from the third media layer. When using glass fibers in particular, this prevents discharge of material of one or more media layers on the downstream side of the filter medium.

The nanofiber layer may have a degree of separation of more than 99.5% for particles larger than 4 μm according to ISO 19138 in a particularly advantageous manner, so that residual particles are also removed from the fluid by this fiber layer.

In an advantageous embodiment variant, the media layer provides the oncoming flow side of the filter medium. Alternatively, only one or more media layers that have a lower degree of particle separation than the first media layer are arranged on the first media layer. The oncoming flow of the first media layer is therefore not blocked by a denser preceding media layer.

A filter element according to the invention has a filter medium according to claim 1. It is designed to be pleatable and is shaped into a star shape to form a round body. The filter element also has two end disks, between which the round body formed from the filter medium is arranged, in particular being held there.

The filter medium according to the invention can be used for filtering gaseous as well as liquid fluids. This permits efficient removal of particles from the fluid with long lifetimes at the same time. Especially long lifetimes are achieved when using the filter medium for filtering fuel in an internal combustion engine. The filter element according to the invention may thus be used as a fuel filter. Diesel fuel in particular can be cleaned reliably by this filter medium.

The filter medium according to the invention with the at least three layers of material may of course also be supplemented by additional layers of materials. In a particularly preferred embodiment variant, the degree of particle separation in the direction of flow increases from one layer of material to the next in the sequence of additional material layers arranged between the first and third layers of material.

A few additional preferred embodiment variants of the filter medium are described below.

First, second and third media layers of the filter medium may especially advantageously consist essentially of glass fibers. In this context, “essentially” means that the layers consist of more than 75 wt % glass fibers, in particular more than 90 wt %. Additional materials may include, for example, plastic binders. In a particularly preferred embodiment variant, the plastic binder may be applied to or introduced into the glass fiber material in the form of threads or in spots.

The filter medium may be embodied in particular as a pleatable filter medium, which retains the folds after being pleated and not revert back to a flat filter medium.

In particular when using media layers containing glass fibers, an additional barrier layer is advantageous to prevent the glass fibers from floating out because they have a high abrasive effect. Since glass fiber layers also do not have enough stiffness to maintain an applied fold structure, it is also favorable in terms of processability to provide a layer having a great stiffness to permit a star-shaped pleating in the filter element. This layer typically consists of a spun-bonded layer or a cellulose layer or a mesh or a combination of several of these layers.

The first through third media layers may especially advantageously contain fibers with an average fiber diameter between 0.2 μm and 4 μm, preferably between 0.5 μm and 3.8 μm.

Each of the first and/or second and/or third media layers may advantageously have a gradient structure of a packing density of fibers with an increasing packing density in the intended direction of flow.

In addition or as an alternative to the nanofiber layer, the filter medium may also have a supporting layer to increase stiffness on the downstream side of the third media layer. This supporting layer may consist of a nonwoven material, for example, into and/or on which nanofibers are additionally applied. The nanofiber layer may be formed in this way. The base material of continuous fibers has a high air permeability, while also having a high stiffness at the same time. The base material can be produced in a two-step process. In the first production step, the polymer yarn is extruded and spun. The core and sheath materials can be selected separately while varying the core-to-sheath ratio and the total thread gauge. In the second production step the continuous fibers are laid one above the other with up to four fiber layers and then are bonded thermally at the points of intersection. This results in a very open-pored, three-dimensional nonwoven. Separation of any glass fibers that are flushed out is ensured by the additional application of nanofibers on the oncoming flow side of the fabric nonwoven.

A reduction in the total height of the filter element can be achieved by combining the functions of stiffness and barrier layer for glass fibers in a single filter medium. There is thus an additional increase in the particle uptake capacity and the lifetime. Thus, at a given capacity, the design size of the total filter can be reduced or the filter can be approved for longer changing intervals.

The second media layer may advantageously have nanofibers with an average fiber diameter between 50 nm and 1000 nm, preferably between 600 nm and 800 nm, and/or the second media layer may be formed at least mostly of nanofibers with an average fiber diameter between 50 nm and 1000 nm, preferably between 600 nm and 800 nm. Doubling the fiber diameter of the nanofibers definitely results in an inferior degree of separation of glass fiber fragments.

The fiber diameter here refers to the median value. A median divides a set of data, a random sample or a distribution into two halves, so that the values in one half are lower than the median value and the values in the other half are higher than the median.

In addition, it is favorable if the nanofiber layer has a weight per unit of area between 0.05 and 10 g/m², preferably between 0.1 and 5 g/m². For example, the weight per unit of area can be determined according to DIN EN 29073-1. A selection of materials that have proven to be favorable for use here includes polymers, cellulose (for example, diacetates) and mineral fibers. If a higher weight per unit of area of nanofibers is advantageous for preventing glass fibers from being flushed out of the media, then a weight per unit of area of more than 10 g/m² is also possible. Mixtures of nanofibers with other fibers, in particular synthetic fibers, are also conceivable.

In one advantageous embodiment, the nanofiber layer may also contain or be formed from electrospun nanofibers. Electrospinning is especially suitable for producing extremely fine fibers and threads for use in filter nonwovens, for example.

The nanofibers layer may advantageously also be formed by coating the third media layer with nanofibers. In this way, the third media layer may also serve as a carrier medium for the relatively thin and less independently stable nanofiber layer.

The first media layer may advantageously contain fibers with an average fiber diameter between 0.2 μm and 4 μm, preferably between 0.5 μm and 4 μm. Favorable degrees of separation by the first media layer of at least 60%, preferably at most 95%, for particles with particle sizes greater than 4 μm can thus be achieved.

It is also favorable if the first media layer is formed by at least 25%, preferably at least 50%, more preferably at most 90% glass fibers. The glass fiber content of the layers can be determined, for example, by means of a thermogravimetric analysis.

The first media layer may advantageously have a gradient structure with a packing density of the fibers such that the packing density increases in the intended direction of flow. In this way, larger particles are separated first in the layers near the surface, while smaller particles are still able to pass through but again are also separated in deeper layers of the first media layer with an increase in packing density. It is thus possible to achieve a particularly favorable lifetime of the filter medium.

The packing density is a measure of the proportion of filter fibers per depth of media layer, i.e., the packing density is to be understood as the packing density of fibers and/or filter fibers per unit of area or unit of volume. This refers in particular to the average packing density and/or the average packing density value of a media layer.

A gradient is understood in conjunction with this document to be a value indicating the rate of change in a variable. The gradient of the packing density, for example, indicates the rate by which the packing density of a filter medium changes in the direction of flow through the filter medium with an increase in the depth and/or thickness of material. The packing density either increases due to a decrease in the number of fiber interspaces or due to a decreasing size of fiber interspaces on a depth section of a media layer.

A gradient of the packing density of the first media layer from an inlet region to an outlet region along the intended direction of flow of the fluid to be filtered may have an increase in the average standardized packing density from 0.07 to 0.12.

In addition, it is favorable if the second media layer is formed by at least 40%, preferably by at least 75%, more preferably by max. 95% glass fibers. In a preferred embodiment variant, the third media layer may contain more than 80% in particular more than 95% glass fibers. Furthermore, an optional nanofiber glass fiber layer may be provided as a barrier layer on the third media layer.

The glass fiber content preferably increases from the first media layer to the second and from the second to the third.

In addition, the third media layer may have a degree of separation of less than 60%, preferably less than 30% for particles with a particle size greater than 4 μm. This ensures that the degree of separation of the third media layer will not become too great and will not become clogged with dirt particles.

In particular, it is advantageous if the third media layer has a thickness of at least 0.15 mm and at most 1.5 mm, preferably at most 0.3 mm in order to achieve the most compact possible structure of a filter medium at a given uptake capacity of the third media layer.

The thickness of nonwovens is usually determined according to DIN EN ISO 9073-2. Samples are taken from 10 different locations of a specimen and tested. The samples may have a size of DIN AS and are measured in two locations at the center of the area. If no samples of this size are available, then smaller samples may also be measured in deviation from this. As a result the individual values of the samples as well as an average value together with the scattering are given in units of mm.

The main filter layers, i.e., at least the third media layer and optionally the second media layer, may advantageously be formed from fibers with an average fiber diameter (median value) of at least 1 μm and max. 40 μm, preferably 20 μm, to thereby achieve the highest possible specific dust uptake.

At least the first media layer and optionally the second media layer, if designed as a prefilter layer, may advantageously have fibers with an average fiber diameter between 0.2 μm and 4 μm, preferably between 0.5 μm and 4 μm. Glass fibers, preferably a blend of short and long fibers, are advantageously used. Short fibers may include cellulose and/or polymers and/or glass, for example, while long fibers may include melt-blown polymers, for example. Mixing ratios of short fibers to long fibers are typically 5% to 80%, preferably 20% to 60% (percent by volume).

The first and/or second and/or third media layer(s) may advantageously have a gradient structure, in particular due to an increasing packing density of the fibers in the intended direction of flow.

### BRIEF DESCRIPTION OF THE DRAWINGS

Additional advantages are derived from the following description of the drawings. The drawings illustrate exemplary embodiments of the invention. The drawings, the description and the claims contain numerous features in combination. Those skilled in the art will also expediently consider the features individually and combine them into appropriate further combinations. For example:

FIG. 1 shows a schematic diagram of a filter medium with three media layers according to one exemplary embodiment of the invention;

FIG. 2 shows a schematic diagram of a filter medium with four media layers according to another exemplary embodiment of the invention and

FIG. 3 shows a schematic diagram of a filter element.

### DESCRIPTION OF THE INVENTION

The figures show only examples and are not to be understood restrictively.

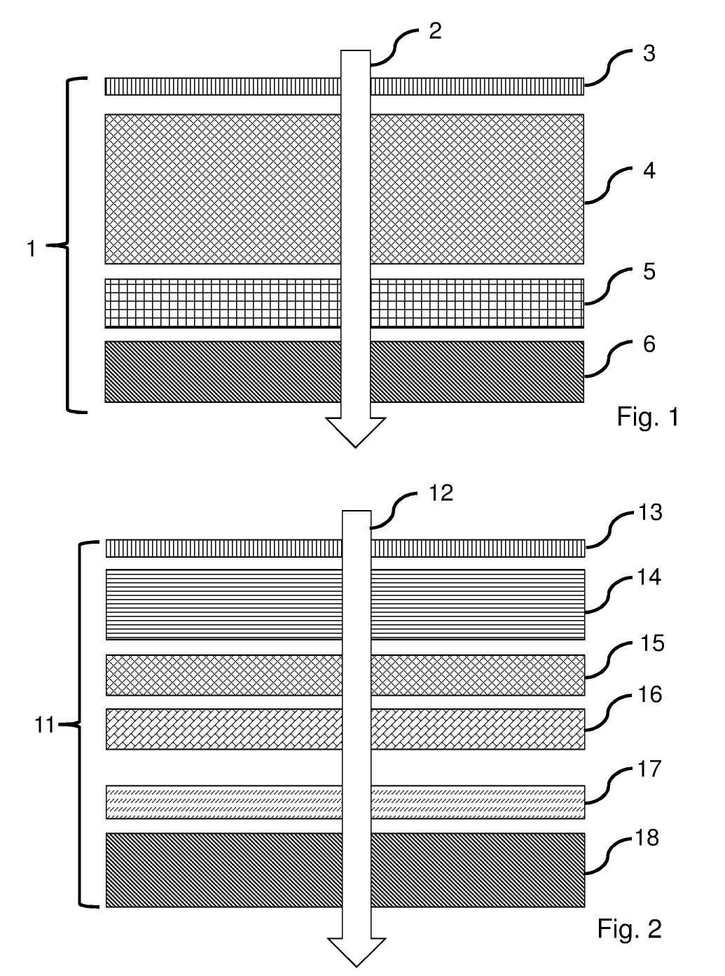

FIG. 1 shows a schematic diagram of a filter medium 1 with four media layers 3, 4, 5 and 6 according to one exemplary embodiment of the invention. The filter medium 1 comprises a first media layer 3, a second media layer 4 and a third media layer 5, wherein the third media layer 5 is arranged downstream from the second media layer 4 in an intended direction of flow 2 through the filter medium 1, and the second media layer 4 is arranged downstream from the third media layer 3 in the intended direction of a flow 2 through the filter medium. The second and third media layers 4 and 5 in the exemplary embodiment have glass fibers and/or consist mostly of glass fibers, while the third media layer 3 is embodied as a spun-bonded layer.

The filter medium also comprises a fourth media layer 6, which may be embodied as a supporting layer. The fourth media layer 6, which is embodied as a supporting layer, may typically consist of a spun-bonded layer or a cellulose layer. In a preferred embodiment variant, the fourth media layer 6 of spun-bonded material or cellulose may additionally be provided with nanofibers, which are added during the production process. Alternatively or additionally, the media layer may also be provided with an additional layer. The base material of the fourth media layer 6 of continuous fibers offers a high air permeability plus a high stiffness at the same time. This results in a very open-pored three-dimensional nonwoven. Due to the additional introduction of nanofibers or due to the application of another material layer (not shown) of nanofibers on the oncoming flow side of the fourth media layer, separation of any glass fibers that are flushed out of the filter medium is improved. If the nanofibers are present as a material layer, then any remaining particles with an average particle size of more than 500 nm or glass fibers that are flushed out can be retained. The weight of the nanofiber layer per unit of area can advantageously be between 0.3 and 80 g/m², preferably 0.5 to 50 g/m². If higher concentrations of nanofibers are favorable for preventing glass fibers from being flushed out, then concentrations of more than 80 g/m² are also possible. The fiber diameter of the nanofibers is preferably between 400 nm and 2 μm, especially preferably between 600 nm and 1 μm.

The fourth media layer 6 ensures that the entire composite of the first, second and third media layers 3, 4 and 5 can also be processed favorably in the production process because the second and third media layers 4 and 5 made of glass fibers are difficult to process due to their great flexibility. To this extent, the stiffness of the supporting layer has a positive effect on the processability of the composite of the four media layers 3-6.

The fourth media layer 6 or the optional nanofiber layer may advantageously have a degree of separation for particles with a particle size greater than 4 μm that is smaller than the degree of separation for particles with a particle size greater than 4 μm of the second media layer, preferably smaller by a factor of 2. In addition, the fourth media layer 6 or the optionally nanofiber layer may have a degree of separation of less than 60%, preferably less than 30% for particles with a particle size greater than 4 μm. In addition, it is favorable if at least the fourth material layer 6 is formed at least 50% (percent by volume) of continuous fibers to thereby achieve the greatest possible stiffness in support of the glass fiber layer of the media layer 12. The fourth media layer 6 may advantageously have a thickness 24 of at least 0.15 mm and at most 1.5 mm, preferably at most 0.3 mm, to thereby achieve the greatest possible specific dust uptake. The fourth media layer 6 may be formed by fibers with an average fiber diameter of at least 1 μm and at most 40 μm, preferably 20 μm. In the case when the fourth media layer also has a nanofiber layer (not shown) in addition to the supporting layer, the nanofibers may have a fiber diameter between 50 nm and 1000 nm, especially preferably between 600 nm and 800 nm, in one advantageous embodiment variant, where a doubling of the fiber diameter of the nanofibers leads to a definitely inferior degree of separation of glass fiber fragments. The nanofiber layer may preferably be formed from electrospun nanofibers and may also preferably be formed by coating the fourth media layer 6 with nanofibers. In one embodiment variant, the fourth media layer 6 may be embodied as a mesh or may be reinforced by a mesh. A mesh-reinforced nanofiber layer may also especially preferably form the fourth media layer 6.

The first media layer 3 is preferably embodied as a spun-bonded layer. The first media layer 3 may contain fibers with an average fiber diameter between 0.2 μm and 4 μm, preferably between 0.5 μm and 5 μm.

The material of the second and third material layers 4 and 5 consists of at least 50 wt % preferably at least 95 wt % glass fibers.

The third material layer 5 has a degree of particle separation η₄ which is greater than the degree of particle separation η₃ of the second material layer 4. The second material layer 4 has a degree of particle separation η₃ which is greater than the degree of particle separation η₂ of the first material layer 3.

In a preferred embodiment variant, the filter medium 1 may contain up to 12 material layers, at least eight material layers of which are provided, whose degree of particle separation n increases in the direction of flow 2. A particularly preferred compromise is a filter medium having five-eight material layers, of which at least four material layers whose degree of particle separation η increases in the direction of flow 2 are provided.

The three material layers 3, 4 and 5 are arranged loosely on one another or are bonded together in spots. For spot bonding, thermoplastic polymer fibers and/or particulate thermoplastic polymer additives may also be present in addition to the glass fibers in one, two or all three material layers 3, 4 and 5, which fuse when they melt and therefore bond the material layers 3, 4 and 5 together in spots. The thermoplastic polymer fibers and/or polymer additives are preferably present as a “middle layer” in the second material layer 4. Bonding over a large area of the three material layers 3, 4 and 5 should be avoided.

Additional material layers, which do not serve primarily the purpose of filtration, may also be provided between the material layers 4 and 5, serving to establish stability or distance between the filter layers.

The connections of individual material layers 3, 4, 5 and 6 may also differ from one another.

The three individual material layers 3, 4 and/or 5 may each have a gradient structure whose porosity decreases in the direction of flow 2. A gradient structure within the material layer 3, 4 or 5 is characterized by a continuous increase in the degree of particle separation. In the case of two material layers 3, 4 or 5, which are arranged loosely in relation to one another or are bonded to one another in spots, however, a gradient discontinuity and/or a stepped gradient may be observed.

Each of the three material layers 3, 4 or 5 may advantageously be constructed so that they have a thickness between 0.1 and 1 mm with a weight per unit of area of preferably 3 g/m². The material layers may, however, also have a higher or lower weight per unit of area. However, the minimum weight per unit of area of each of the three material layers 2, 3 or 4 is limited to 0.2 g/m².

The total thickness of the filter medium 1 may preferably amount to max. 6 mm and is limited to a weight per unit of area of preferably 500 g/m². The degree of separation of the total filter medium 1 may preferably be more than 95% for a fluid loaded with particles having a particle size of more than 4 μm(c) according to ISO 19438 or the beta value may be ≧200 for particle sizes of 4-30 μm(c) according to ISO 16 889.

Due to the sequence of three or more layers with increasing degrees of particle separation in the direction of flow 2, a very defined gradient structure can be established so that a high solids capacity of the filter medium 1 and thus a long lifetime of the filter medium 1 can be achieved.

Due to the multilayer design of the filter medium with the predetermined gradients for the particle filtering, the filter medium has a less remarkable filter behavior in pulsating flow of the fluid to be filtered in comparison with a filter medium without a corresponding gradual increase in the degree of particle separation. If the filter medium is arranged in a vibrating filter space, it will also exhibit a better filter behavior.

For the respective material layers, which have a gradual increase in the degree of particle separation by the sequence of material layers, it has proven to be particularly advantageous if at least one of the material layers consists of more than 50 wt %, in particular more than 95% glass fibers. The material amounts in wt % in the present invention are always based on the amount of solids. Air or gas components in the filter medium are therefore not taken into account.

For the respective material layers which have the gradual increase in the degree of particle separation in the sequence of material layers, melt-blown materials or spun-bonded materials can also be used in addition to material layers based on glass fibers. Alternatively or additionally, blend fibers, e.g., glass fibers with cellulose fibers, glass fibers with synthetic fibers or cellulose fibers with synthetic fibers can fundamentally also be used.

The individual layers can be assembled in a more flexible manner for the filter task and the fluid to be filtered so that depending on the specific application case, a more accurate coordination with the degree of separation required and the lifetime of the filter is possible in comparison with what the filter media would achieve with fewer layers of material or with a sequence of material layers that does not run gradually with respect to the degree of particle separation.

The filter media shown in FIGS. 1 and 2 may advantageously be used in applications requiring a very high degree of separation with a long lifetime at the same time. This is true of fuel filters, for example, and in particular of all main diesel filters. Due to the pronounced and stable gradient structure, the fluid filtering of fuel may take place in the range of the fuel filter through a single filter medium according to the invention. Prefilters and main filters used in the past may thus be omitted, which leads to a considerable cost reduction.

With regard to requirements concerning vibration of the filter medium and pulsating flow, multilayer media can make a significant contribution toward maintaining the degree of separation of the medium at the level required by the respective manufacturer of the injection system.

In filtration of hydraulic oil, reduced degree of separation occurs in the field because of the pulsating flow. A multilayer filter medium according to the invention with a graduated filter effect and/or screen effect according to the invention can have better filter results than could be achieved in the past with filter media having comparable degrees of particle separation with less than three layers.

FIG. 2 shows a schematic diagram of a filter medium 11 with six media layers 13, 14, 15, 16, 17 and 18 according to another exemplary embodiment of the invention. The overall structure of the layer sequence is very similar to that described in FIG. 1. In addition, in a preferred variant, a barrier layer 17 in FIG. 2 is described as a nanofiber layer and a supporting layer 18, namely in the form of a spun-bonded layer here. The nanofiber layer is designed like the nanofiber layer described in FIG. 1.

In addition, FIG. 2 shows another media layer, so that now there is a total of four media layers 13, 14, 15 and 16 which are provided for particle filtration. These include a first and second prefiltration layer 13 and 14, each having a degree of particle separation η₁₃ and η₁₄ of less than 80% for particles with an average particle size of more than 4 μm according to ISO 19138. The degree of particle separation increases in the direction of flow 12.

In the embodiment variant shown in FIG. 1, the degree of particle separation η₁₃ of the first prefiltration layer 13 is preferably less than 50%, in particular between 30% and 45% for particles with an average particle size of more than 4 μm according to ISO 19138.

The degree of particle separation η₁₄ of the second prefiltration layer 14 is preferably between 60% and 78% for particles having an average particle size of more than 4 μm according to ISO 19138. This second prefiltration layer 14 is arranged downstream from the first prefiltration layer 13.

The two prefiltration layers 13 and 14, which permit filtration of coarser particles followed by a first and a second main filtration layer 15 and 16, each having a degree of particle separation η₁₅ and η₁₆ of preferably more than 80% for particles with an average particle size of more than 4 μm according to ISO 19138.

The first main filtration layer 15 may have a degree of particle separation η₁₅ of less than 95%, in particular between 81 and 94%, for particles with an average particle size of more than 4 μm according to ISO 19138. The second main filtration layer 16 may have a degree of particle separation η₁₆ of more than 98% for particles with an average particle size of more than 4 μm according to ISO 19138. The second main filtration layer 16 is arranged in the direction of flow 12 downstream from the first main filtration layer 15.

In the direction of flow 12 downstream from the second main filtration layer 16, said barrier layer 17 of nanofibers is arranged, its structure and functioning having already been explained in the exemplary embodiment in FIG. 1. This barrier layer 16 has a degree of particle separation η₁₇ of more than 99.5% for particles having an average particle size of more than 4 μm according to ISO 19138.

By analog with the filtration medium of FIG. 1, a supporting layer 18 is arranged downstream from this barrier layer 17. This supporting layer may be a mesh layer or a spun-bonded layer, for example. In comparison with the barrier layer 17, it has a lower degree of particle separation η₁₈. The degree of particle separation may preferably amount to less than 80% for particles with an average particle size of more than 4 μm according to ISO 19138, according to the version at the point in time of the initial patent application filed for the present invention. The supporting layer 18 is thus excluded from the structure of the material layers, which have a gradual increase in the degree of particle separation according to the invention.

For the respective material layers 13-16, which have the gradual increase in the degree of particle separation in the sequence of the material layers, glass fiber layers may be used especially preferably. However, in addition to glass fibers, melt-blown materials or spun-bonded materials may also be used. Alternatively or additionally, mixed fibers, for example, glass fibers with cellulose fibers, glass fibers with synthetic fibers or cellulose fibers with synthetic fibers may also be used.

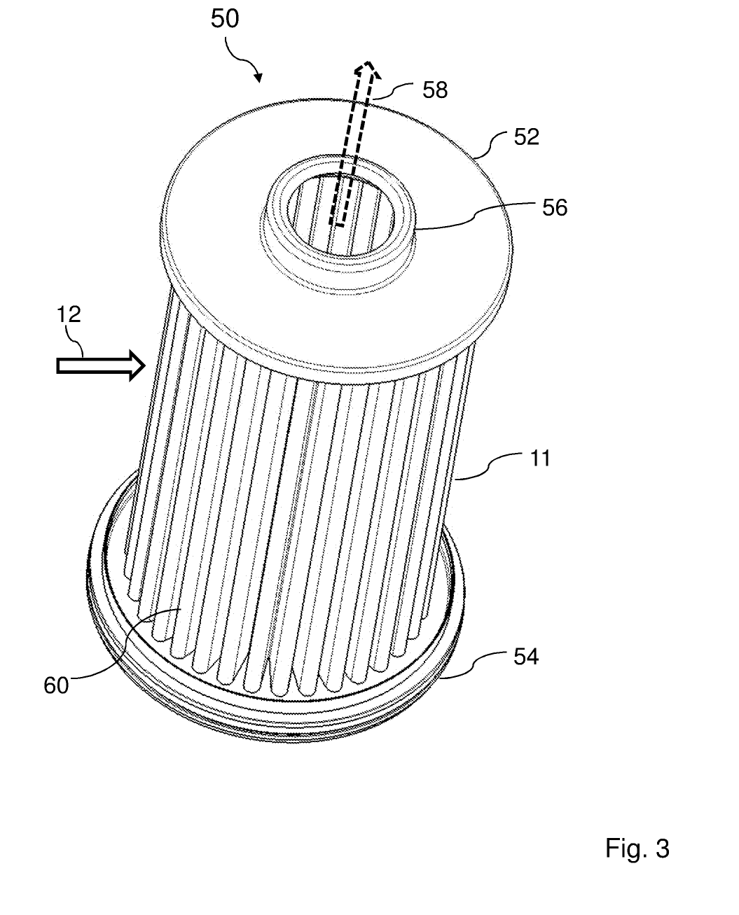

FIG. 3 shows a filter element 50 having a pleated filter element 11 according to the exemplary embodiment in FIG. 2. The filter medium 11 is pleated in a star pattern to form a round body which is sealed at both ends with a first end disk 52 and a second end disk 54. These two end disks 52, 54 serve to receive and secure as well as to seal the filter element 50 in a housing of a filter system. Folded edges 60 running parallel to the longitudinal direction of the supporting layer of the filter medium 11 can be seen clearly on the outside circumference of the round body of the filter medium 11, while a transverse direction of the supporting layer runs perpendicular to the former. The direction of flow 12 of a fluid through the filter element 50 is radially from the outside to the inside into the round body of the filter medium 11, where the filtered fluid can then flow out again axially through an outlet 56 out of the filter element 50 in the direction of outflow 58. In such an exemplary embodiment, the filter element 50 may be used as a fuel filter for an internal combustion engine, for example.

1. A filter medium (1, 11) comprising:
a first media layer (3, 13);
a second media layer (4, 14); and
at least one third media layer (5, 15 or 16);
wherein the second media layer (4, 14) is arranged downstream from the first media layer (3, 13) in the intended direction of flow (2, 12) of the filter medium (1, 11);
wherein the third media layer (5, 15) is arranged downstream from the second media layer (4, 14) in the intended direction of flow (2, 12) through the filter medium;
wherein the first media layer has a degree of particle separation, which is lower than the degree of particle separation of the second media layer;
wherein the second media layer has a degree of particle separation which is lower than the degree of particle separation of the third media layer; and
wherein the media layers (3, 4, 5, 13, 14, 15) are arranged loosely and not bonded to one another, or are arranged loosely and bonded in a spot-bonded manner.

2. The filter medium according to claim 1, wherein
the first, second and third media layers (3, 4, 5, 13, 14, 15) consist essentially of glass fibers.

3. The filter medium according to claim 1, wherein
at least one of the second and/or third media layers (4, 5, 16) has a degree of particle separation of more than 95% for particles larger than 4 μm according to ISO 19138.

4. The filter medium according to claim 1, wherein
at least one of the first and/or second media layers (3, 13, 4, 14) has/have a degree of particle separation of less than 90% for particles larger than 4 μm according to ISO 19138.

5. The filter medium according to claim 1, wherein
at least one of the at least three media layers (3, 13, 4, 14, 5, 15, 16) comprises at least 20 wt % glass fibers.

6. The filter medium according to claim 5, wherein
at least one of the at least three media layers (3, 13, 4, 14, 5, 15, 16) comprises at least 95 wt % glass fibers.

7. The filter medium according to claim 1, wherein
degrees of particle separation for particles larger than 4 μm according to ISO19138 of at least two of the media layers (3, 13, 4, 14, 5, 15, 16) differ from one another by at least 5%.

8. The filter medium according to claim 1, wherein
the first media layer (3, 13) has a degree of particle separation of between 20% and 49%, for particles larger than 4 μm according to ISO 19138;
the second media layer (4, 14, 15) has a degree of particle separation between 50% and 95% for particles larger than 4 μm according to ISO 19138; and
the third media layer (5, 16) has a degree of particle separation between 98% and 99.5% for particles larger than 4 μm according to ISO 19138.

9. A filter medium (1, 11) comprising:
a first media layer (3, 13);
a second media layer (4, 14); and
at least one third media layer (5, 15 or 16);
wherein the second media layer (4, 14) is arranged downstream from the first media layer (3, 13) in the intended direction of flow (2, 12) of the filter medium (1, 11);
wherein the third media layer (5, 15) is arranged downstream from the second media layer (4, 14) in the intended direction of flow (2, 12) through the filter medium;
wherein the first media layer has a degree of particle separation, which is lower than the degree of particle separation of the second media layer;
wherein the second media layer has a degree of particle separation which is lower than the degree of particle separation of the third media layer; and
wherein the media layers (3, 4, 5, 13, 14, 15) are not bonded to one another in a firmly bonded manner or in a spot-bonded manner.
wherein the layers (3, 13, 4, 14, 5, 15, 16) are bonded to one another in a firmly bonded manner over less than 3% of the area content, remaining area being unbonded.

10. The filter medium according to claim 1, wherein
the filter medium (1, 11) has a nanofiber layer (17) downstream from the third media layer (5, 16) in an intended direction of flow (2, 12) of the filter medium (1, 11) downstream from the third media layer (5, 16).

11. The filter medium according to claim 10, wherein
the nanofiber layer (17) has a degree of particle separation of more than 99.5% for particles larger than 4 μm according to ISO 19138.

12. The filter medium according to claim 1, wherein
the first media layer (3, 13) at an oncoming flow side of the filter medium or at least one additional media layer is arranged on the first media layer (3, 13); and
the at least one additional media layer has a lower degree of particle separation than the first media layer (3, 13).

13. The filter element comprising:
a filter medium, including:
a first media layer (3, 13);
a second media layer (4, 14); and
at least one third media layer (5, 15 or 16);
wherein the second media layer (4, 14) is arranged downstream from the first media layer (3, 13) in the intended direction of flow (2, 12) of the filter medium (1, 11);
wherein the third media layer (5, 15) is arranged downstream from the second media layer (4, 14) in the intended direction of flow (2, 12) through the filter medium;
wherein the first media layer has a degree of particle separation, which is lower than the degree of particle separation of the second media layer;
wherein the second media layer has a degree of particle separation which is lower than the degree of particle separation of the third media layer; and
wherein the media layers (3, 4, 5, 13, 14, 15) are not bonded to one another, or wherein the layers (3, 13, 4, 14, 5, 15, 16) are bonded to one another in a firmly bonded manner over less than 3% of layer area, remaining area being unbonded;
wherein the filter medium (1, 11) is pleated in the form of a star to form a round filter body;
two end disks (52, 54) between which the round filter body formed from the filter medium (1, 11) is arranged.

14. A use of the filter element (50) according to claim 13 for filtering diesel fuel in an internal combustion engine.
